(19) United States
(12) Patent Application Publication
(10) Pub. No.: US 2023/0392095 A1
(43) Pub. Date: Dec. 7, 2023

(54) FRAGRANCE CONCRETE AND ABSOLUTE OBTAINED BY EXTRACTION OF HETEROCYCLIC SOLVENT FROM SOLID NATURAL MATERIALS

(71) Applicant: L'OREAL, Paris (FR)

(72) Inventors: Géraldine DU ROIZEL, Aulnay-Sous-Bois (FR); Hervé DAVID, Aulnay-Sous-Bois (FR)

(21) Appl. No.: 18/249,157

(22) PCT Filed: Oct. 14, 2021
(86) PCT No.: PCT/EP2021/078452

§ 371 Date: Apr. 14, 2023

(30) Foreign Application Priority Data
Oct. 16, 2020 (FR) FR2010661

(51) Int. Cl. C11B 9/00; C11B 9/02

(52) U.S. Cl. CPC C11B 9/0003; C11B 9/025

(57) ABSTRACT

The present invention relates to a process for the preparation of perfume concrete and absolute which employs bringing particular solid natural material into contact with a first system of solvents comprising at least one “green” heterocyclic solvent.

Another subject-matter of the invention is the perfume concrete and the perfume absolute obtained by the preparation process, a composition comprising the concrete and/or the absolute, and the use of the “green” heterocyclic solvent to extract the concrete and/or the absolute without lamenting an ether odour.

The present invention relates to a process for the preparation of perfume concrete and/or absolute which employs bringing particular, fresh, withered or dry, solid natural material(s) into contact with a first system of solvents comprising at least one “green” heterocyclic solvent. Another subject-matter of the invention is the perfume concrete and the perfume absolute obtained by the preparation process, a composition comprising the concrete and/or the absolute, and the use of the “green” heterocyclic solvent to extract the concrete and/or the absolute without lamenting a chemical odour of solvent odour type, such as an ether odour.

The cosmetics industry and in particular the perfumery industry includes numerous processes for the extraction of odorous molecules, such as enfleurage, hydrodistillation, expression, atomization, extraction with supercritical CO₂, and the like. Among these, extraction by non-polar volatile solvents, such as n-hexane, represents, for certain natural raw materials, a good technique for the extraction of odorous molecules, in particular by virtue of a good dissolving power, a lower boiling point than water and easy vacuum distillation. This technique is favoured for the large-scale production of absolutes, used as raw materials in perfumery, in particular in the case where hydrodistillation could not be applied due to the high boiling point of water, which could detrimentally affect the natural raw materials, in particular plant raw materials. By this process, natural materials, in particular plant materials, are subjected to several successive washing operations with a first volatile organic solvent 1. Separation by settling and then the evaporation under vacuum of the solvent 1 make it possible to obtain the “concrete”. An optional treatment of the “concrete” with a second solvent 2, in particular ethanol, makes it possible to remove the impurities present (waxes, and the like) and thus to obtain the “absolute” after evaporation of the solvent 2 (see Kirk-Othmer Encyclopedia of Chemical Technology, “Perfumes”, John Wiley & Sons Inc., K. D. Perring, pp. 1 to 46 (2016) DOI: 10.1002/0471238961.1605180619030818.a01.pub3, and Ullmann's Encyclopedia of Industrial Chemistry, “Perfumes”, M. V. Ende, W. Sturm and K. Peters, Wiley-VCH Verlag GmbH & Co. KGaA, Weinheim, (2017) https://onlinelibrary.wiley.com/doi/epdf/10.1002/14356007.a19_171.pub2). Among these different extraction techniques, extraction by volatile solvents is the favoured method for obtaining “concretes” and then “absolutes” of certain natural materials, such as perfumery raw materials. To do this, solvents of petroleum origin, in particular aliphatic solvents, are chosen especially as solvent 1 (see, for example, Kirk-Othmer Encyclopedia of Chemical Technology, “Perfumes”, John Wiley & Sons Inc., K. D. Perring, pp. 1 to 46 (2016) DOI: 10.1002/0471238961.1605180619030818.a01.pub3, and Ullmann's Encyclopedia of Industrial Chemistry, “Perfumes”, M. V. Ende, W. Sturm and K. Peters, Wiley-VCH Verlag GmbH & Co. KGaA, Weinheim, (2017) https://onlinelibrary.wiley.com/doi/epdf/10.1002/14356007.a19_171.pub2).

For example, n-hexane is often used on the industrial scale due to a low cost price and its ability to dissolve a great variety of products, including vegetable oils, flavourings, fragrances and colours. On the other hand, n-hexane is a non-renewable solvent which is not very environmentally friendly. Moreover, the nature of the extraction solvent can result in a chemical odour, such as an ether odour, which differs from the odour of the original solid natural material.

It is thus of great advantage to find an alternative process for the preparation of concretes and/or absolutes which employs, in its process, a “green” extraction solvent in place of solvent of petroleum origin, such as hexane, and which in addition does not denature the odour of the absolute or which does not leave a “chemical odour”, such as, for example, an ether odour, in the absolute.

In 1991, the concept of Green Chemistry was put forward. Its guiding principle is to reduce or eliminate at source the use of hazardous substances in the design of new products. Subsequently, twelve principles of green chemistry were proposed, “Green Chemistry: Theory and Practice”, Oxford Science, New York, P. T. Anastas et al. (1998). The indicators of green chemistry, such as the E-factor or the economy of atoms, make it possible to measure the various aspects of a chemical process by referring to the principles of green chemistry (see, for example, Kirk-Othmer Encyclopedia of Chemical Technology, Green Chemistry, Michael A. Matthews, Vol. 12, pp. 799 to 818, Apr. 19, 2013, https://doi.org/10.1002/0471238961.0718050513012020.a0l, and ibid., Green Chemistry, Applications, Albert S. Matlack, pp. 1 to 33, https://doi.org/10.1002/0471238961.greematl.a01).

Natural material extraction with heptane has been described in order to obtain concretes and absolutes starting from n-heptane solvent of petrochemical origin and resulting from a Commiphora wildii plant source (WO 2019/149701). Nevertheless, the yields of concretes and absolutes are not always satisfactory with respect to the starting raw material. In addition, the odour can be less pleasant or more remote from that of the natural material with a “chemical” note.

Furthermore, documents describe the use of 2-methyltetrahydrofuran (or 2-MeTHF) as “green” solvent (renewable, biodegradable and BIO compatible (COSMOS reference system)), as replacement for n-hexane for extracting natural products (see, for example, WO 2011/092334).

It is also desirable to be able to extract a concrete and/or an absolute from solid natural material which is fresh, withered or dry, in particular plant natural material, starting from “green” solvent without having to lament a change in odour of the concrete and/or the absolute or an olfactory trace of the solvent which made it possible to extract said concrete(s) and absolute(s), in particular an odour of “non-natural” product, such as ether. Moreover, it is of great advantage to obtain extraction yields which are very markedly improved in comparison with conventional extraction solvents.

These technical problems have been solved by the process of the invention.

A subject-matter of the invention is thus a process for the preparation of a perfume concrete and/or absolute employing at least one stage a) of bringing a first system of solvents comprising at least one heterocyclic solvent having a boiling point at atmospheric pressure of greater than or equal to 70° C., particularly of between 70° C. and 110° C., preferably of between 70° C. and 100° C.; preferentially, the heterocyclic solvent(s) is(are) chosen from a1) to a4) as defined below, into contact with:
b) one or more fresh, withered or dry solid natural material(s) chosen from:
   i) rose (Rosa Plathyrhodon, Rosa Hesperhodos, Rosa Hulthemia and Rosa Eurosa and more particularly Rosa Centifolia and Rosa Damascena) flowers, jasmine (Jasminum and more particularly Jasminum grandiflorum and Jasminum sambac) flowers, lavender flowers, lavandin (Lavandin stoechas, Lavandula hybrida, Lavandula augustifolia, formerly officinalis, and Lavandula latifolia and more particularly Lavandula hybrida abrial, Lavandula hybrida grosso, Lavandula hybrida reydovan, Lavandula hybrida sumian and Lavandula hybrida super) flowers, orange (Citrus sinensis or sour orange Citrus aurantium L) blossom, flowers of tuberoses (Agave polianthes or Polianthes tuberosa), ylang-ylang (Cananga odorata) flowers, violet (Viola odorata var. Victoria) flowers and mimosa (Acacia dealbata, Acacia decurrens) flowers;
   ii) geranium (Pelargonium with in particular Cicconium, Magnipetala, Parvulipetala, Paucisignata and more particularly Pelargonium graveolens) stems and leaves, patchouli (Pogostemon cablin and Pogostemon heyanus) stems and leaves and petitgrain (Citrus aurantium, more particularly Citrus aurantium ssp. amara, or Citrus var. bigaradia, or Citrus aurantium ssp. aurantium) stems and leaves;
   iii) fruits chosen from anise (Pimpinella anisum), coriander (Coriandrum sativum), caraway (Carum carvi), cumin (Cuminum cyminum) and juniper (Juniperus, more particularly Juniperus communis, Juniperus oxycedrus, Juniperus thurifera, Juniperus phoenicea L.);
   iv) citrus fruits, such as bergamot (Citrus bergamia), lemon (Citronella, Citrus limonum), mandarin (Citrus reticulata) or grapefruit (Citrus paradisi); preferably bergamot or grapefruit;
      (bergamot), varieties of (lemon), varieties of Citrus reticulata (mandarin), varieties of (grapefruit); preferably Citrus bergamia (bergamot), or Citrus paradisi (grapefruit);
   v) mace (Myristica fragrans) seeds, angelica (Angelica archangelica) seeds, celery (Apium graveolens) seeds and cardamom (Elettaria cardamumum) seeds, tonka (Dipteryx odorata) seeds and beans, vanilla (Vanilla planifolia) pods and/or seeds, preferably cardamom (Elettaria cardamumum) seeds;
   vi) angelica (Angelica archangelica) roots, vetiver (Vetiveria and more particularly Vetiveria zizanoïde, Vetiveria nemoralis and Vetiveria nigritana) roots and iris, particularly Iris germanica and Iris pallida, roots;
   vii) sandalwoods (Santalum and more particularly Santalum album, Santalum ellipticum, Santalum spicatum), rosewoods (Aniba rosaeodora), cedarwoods (Cedrus, more particularly Cedrus atlantica and Cedrus juniperus) and guaiacumwoods (Bulnesia sarmientioi, Guaiacum officinale and Guaiacum sanctum);
   viii) herbs and grasses chosen from tarragon (Artemisia dracunculus), lemon grass (Cymbopogon and more particularly Cymbopogon citratus), sage (Salvia and more particularly Salvia officinalis and Salvia sclarea), mint (Mentha and more particularly Mentha aquatica, Mentha canadensis, Mentha spicata) and thyme (Thymus, more particularly Thymus vulgaris and Thymus zygis);
   ix) spruce needles and twigs, fir (Abies and more particularly Abies alba) needles and twigs, rosemary (Salvia rosmarinus, formerly Romarinus officinalis) needles and twigs, and pine (Pinus and more particularly Pinus sylvestris) needles and twigs;
   and
   x) resins and balms derived from galbanum (Ferula galbaniflua or Ferula gummosa), elemi (Canarium and more particularly Canarium commune, Canarium luzonicum and Canarium indicum), benzoin (Styrax and more particularly Styrax tonkiniensis and Styrax benzoin), myrrh (Commiphora myrrha or Commiphora molmol and Commiphora opobalsamum) and olibanum (Boswellia, more particularly Boswellia sacra);
it being understood that the seeds or beans v) can be with or without shells, preferably without shells.

Another subject-matter of the invention is a concrete and/or an absolute obtained from the preparation process as defined above.

Another subject-matter is a composition, in particular a cosmetic composition, comprising at least one concrete and/or at least one absolute, it being understood that said concrete(s) and/or said absolute(s) is(are) obtained by the preparation process as defined above.

Another subject-matter of the invention is a method for the treatment of keratin materials, in particular human keratin materials, such as the skin, or human keratin fibres, such as the hair, employing the application, to the keratin materials, of concrete(s) and/or of absolute(s) obtained from the preparation process as defined above, it being understood that the concrete(s) and/or the absolute(s) can be contained in a cosmetic composition.

Another subject-matter of the invention is a process for perfuming a support i), such as:
keratin materials, in particular human keratin materials, such as the skin, or human keratin fibres, such as the hair,
textile materials, such as natural materials, for example cotton, flax, silk and wool, or synthetic materials, such as polyamides, for example nylon, polyesters, acrylics, elastanes, such as Spandex® and Lycra®,
wood,
paper,
articles made of leather, such as shoes or gloves, and/or
the atmosphere ii) (ambience perfumes, wardrobe fragrances), employing one or more concrete(s) as defined below and/or one or more absolute(s) as defined below, by application or spraying of the concrete(s) and/or of the absolute(s) over the support(s) i) or into the ambient air ii), it being understood that the concrete and/or the absolute can be contained in a composition as defined below.

Another subject-matter of the invention is the use of a system of solvent(s) a) comprising at least one heterocyclic solvent having a boiling point at atmospheric pressure of greater than or equal to 70° C.; preferably, the heterocyclic solvent(s) is(are) chosen from a1) to a4) as defined below, particularly chosen from a1) and a4), more particularly denotes in particular a THF derivative, such as 2-MeTHF or CPME, preferably 2-MeTHF as defined above, in order to extract a perfume concrete and/or a perfume absolute from fresh, withered or dry solid natural material(s), i) to x) b) as defined above, without lamenting a chemical odour, such as a solvent odour, in particular an ether odour.

Another subject-matter of the invention is the use of one or more concretes and/or of one or more absolutes which are obtained according to the preparation process as defined above for the perfuming of a support i), such as:
keratin materials, in particular human keratin materials, such as the skin, or human keratin fibres, such as the hair,
textile materials, such as natural materials, for example cotton, flax, silk and wool, or synthetic materials, such as polyamides, for example nylon, polyesters, acrylics, elastanes, such as Spandex® and Lycra®,
wood,
paper,
articles made of leather, such as shoes or gloves, and/or
the atmosphere ii) (ambience perfumes, wardrobe fragrances).

It appears, unexpectedly, that the odours of (the) concrete(s) and/or absolute(s) according to the invention, in particular those floral or resulting from seeds, deteriorate only slightly and remain persistent over time, and/or after application to keratin materials, in particular to the skin or to keratin fibres, such as the hair. In particular, the notes of perfumes of (the) concrete(s) and/or absolute(s) according to the invention are and/or remain powerful over time. Furthermore, the concrete(s) and/or the absolute(s) obtained according to the process of the invention are relatively stable with regard to external attacks, such as light, temperature and/or sweat.

In addition, the process for the preparation of concrete and/or absolute according to the invention makes it possible in particular to obtain concretes and/or absolutes with a very satisfactory yield (at least comparable to those obtained with solvents of petroleum origin, in particular aliphatic solvents, such as heptane) and having odours very close to the starting solid natural raw materials, without lamenting a “non-natural” olfactory trace related to the heterocyclic solvent, such as olfactory traces of ether. For example, on the olfactory level, the cardamom absolute obtained by the process according to the invention has a characteristic odour of cardamom seed without any ether note, and closer to the natural odour than that obtained with the extraction of aliphatic solvents, such as heptane. The odorous extracts contained in the concretes and/or absolutes of the invention have an odour substantially similar to that of the starting plant raw material. The concretes and/or absolutes of the invention can be used in perfumery, in cosmetics and also for the perfuming of supports i) as described above or of atmosphere.

Within the meaning of the present invention and unless otherwise indicated:

The term “grinding”, also called “comminution”, “attrition” or “crushing”, is understood to mean the operation consisting in dividing the solid natural material(s) down to the powder state, preferably fine powder state, preferably with a size of the particles of the powder of less than 900 μm; advantageously, the size of the particles is between 10 μm and 500 μm.

The term “powder” is understood to mean a composition in the pulverulent form, preferably essentially devoid of dust. In other words, the particle size distribution of the particles is such that the content by weight of the particles which have a size of less than or equal to 50 micrometres (content of dust), preferably of less than or equal to 10 micrometres (content of dust), is advantageously less than or equal to 5%, preferably less than 2% and more particularly less than 1% (size of the particles evaluated by means of a Retsch AS 200 Digit particle size analyser; oscillation height: 1.25 mm/sieving time: 5 minutes). Advantageously, the size of the particles is between 10 μm and 500 μm. The “powder” of solid natural material(s) can be sieved in order to obtain particles with upper limit sizes corresponding to the orifices or sizes of the meshes of the sieve of particularly between 35 and 80 mesh (US). According to a particular mode of the invention, the size of the particles of the powder of solid natural material(s) is fine. According to the invention, a size of particles of less than or equal to 900 μm is more particularly meant. Preferentially, the powder is constituted of fine particles with a size of between 7 and 700 μm and better still between 100 nm and 500 μm.

The term “dry” material is understood to mean a plant raw material from which water has been withdrawn; preferably, the water content is between 0% and 10%, preferably less than 5%, more preferentially still less than 2%, better still less than 1%, such as less than 0.5%, by weight, with respect to the total weight of said solid material, in or not in powder form.

The term “fresh” is understood to mean the hydrated material from which water has not been withdrawn; it was preferably harvested from a few hours to a few days (up to 15 days) before bringing into contact with the solvent(s) and was maintained at a compatible temperature and with a relative humidity making it possible to maintain the water content in said material with +/−2% of water; preferably, the fresh materials have a water content of greater than 10% by weight of water, with respect to the total weight of said solid material, in or not in powder form. More preferentially, the fresh material(s) of the invention is(are) chosen from flowers, such as jasmine flowers, mimosa flowers, rose flowers, flowers of tuberoses, orange blossom and ylang-ylang flowers, and preferably these flowers are treated with the process of the invention in the day after picking, or in 2 to 5 days after picking, having taken care to have kept the flowers at a temperature of between 1° C. and 5° C.

The term “withered” is understood to mean a plant raw material which is a particular fresh material, the flowering of which is terminated, and/or the dry material is stored for one to several days (up to 15 days) before being treated by the process according to the invention and from which, in addition, water has been withdrawn in an amount of less than 80% by weight, preferably of less than 50% by weight, such as 1% to 40% by weight, in particular 1% to 20% by weight.

The term “natural material” is understood to mean a raw material of plant origin.

The term “perfume raw material” is understood to mean a material in the crude state extracted from nature comprising olfactory active principles used in perfumery, or in the preparation of perfumes.

The term “perfume” is understood to mean a particular olfactory composition, highly concentrated, provided packaged and having a high olfactory concentration. The term “perfume” is also understood to mean an eau de toilette, an eau de parfum or an eau de Cologne.

In general, perfumes are constituted of a mixture of “perfumery” ingredients which can also be classified into head notes, heart notes and base notes. The three notes correspond to the greater or lesser volatility of the ingredients of which they are composed: highly volatile head note, moderately volatile heart note and sparingly volatile base note.
(i) The head note, also called “top” note, is that which is first perceived by the sense of smell as soon as the perfume is in contact with the keratin material or any other substrate. However, it is the note which fades the fastest: it does not “last”. It is difficult to express the time of persistence of this note, since it is very variable: from a few minutes to about ten minutes. It is essentially fresh and light. All the citrus fruits belong in particular to this category. In perfumery, they are grouped under the generic term hesperidean notes, which include orange, lemon, grapefruit, bergamot, orange blossom, neroli, and the like. Mention will also be made of herbal notes, such as lavender, laurel, thyme or rosemary, and anise, menthol, aldehyde, and the like, notes. Mention will also be made of eucalyptus notes.
(ii) The heart note, sometimes also called “middle note”, has a persistence which lasts from a few tens of minutes to a few hours, but its main characteristic is that it is not perceived until after a few minutes. Thus, it “starts” just before the head note dies off. It begins to express itself while the head note is gradually fading away. It is represented essentially by floral, fruity or spicy scents: lily of the valley, honeysuckle, violet, magnolia, cinnamon, geranium, jasmine, rose, iris, raspberry, peach, and the like.
(iii) The base note, sometimes also called “bottom note”, gives a perfume its “durability”, persistence or staying power. It is perceptible several hours, indeed even several days, or even several weeks, after application onto clothing or onto a perfume blotter or scent strip, depending on the concentration of the perfume. Mention will be made, for example, of woods, roots, mosses, resins and animal or mineral substances, such as opoponax, musks, amber, sandalwood, benzoin, lichen, clove, sage, and the like. Mention will also be made of vanilla, patchouli, coumarin, and the like, notes.

The term “plant” is understood to mean the group of photosynthetic organisms, the cells of which have a wall constituted of cellulose.

The term “solid” is understood to mean that the raw material has a consistency, which is not liquid at ambient temperature (25° C.) and atmospheric pressure (760 mmHg), that is to say a composition of high consistency, which retains its shape during storage. In contrast to “fluid” or “liquid” compositions, it does not flow under its own weight, while being able to be more or less soft.

The term “solvent” is understood to mean a substance which is liquid at ambient temperature (25° C.) and at atmospheric pressure, which has the property of dissolving, diluting or extracting other substances without chemically modifying them and without itself being chemically modified.

The term “organic solvent” is understood to mean an organic substance, preferably liquid at ambient temperature and atmospheric pressure, capable of dissolving or dispersing another substance without chemically modifying it.

The term “anhydrous” is understood to mean, within the meaning of the present invention, a liquid phase exhibiting a water content of less than 5% by weight, preferably of less than 2% by weight and more preferably still of less than 1% by weight, with respect to the weight of said liquid phase, indeed even again of less than 0.5% and in particular devoid of water, the water not being added during the preparation of the liquid phase but corresponding to the residual water introduced by the ingredients mixed.

The term “system of solvents” is understood to mean just one solvent or a mixture of several solvents, preferably two or three solvents, if the system of solvents is a mixture of solvents; preferably, all the solvents are “green”.

When reference is made to the temperature of the boiling point of the system of solvents comprising a mixture of solvents, it is understood that the boiling point of each solvent of said mixture must observe the temperature in question, i.e. have a boiling point greater than the temperature greater than or equal to 70° C., in particular chosen between 70° C. and 110° C., preferably between 70° C. and 100° C.

The term “green” solvent is understood to mean a solvent which observes at least one of the 12 principles of green chemistry.

The term “heterocyclic” is understood to mean that the solvent is a 5- to 7-membered monocycle, preferably saturated, comprising from 1 to 3 heteroatom(s)—preferably oxygen—within its ring and/or outside the ring, in particular 1 oxygen atom in the ring, said ring additionally comprising from 4 to 6 carbon atoms, and it being possible for said monocycle to be substituted by one or more linear or branched (C₁-C₄)alkyl groups, preferably linear, such as methyl.

The term “solid/liquid extraction” or “leaching” is understood to mean the process for completely or partially extracting one or more compounds of natural material in an appropriate solvent. Solid/liquid extraction (also symbolized by “liquid-solid”) covers a variety of extraction processes known to a person skilled in the art (see Extraction Liquid-Solid, Kirk-Othmer Encyclopedia of Chemical Technology, Richard J. Wakeman (2000); https://doi.org/10.1002/0471238961.1209172123011105.a01, and Extraction Liquid-Solid, Ullmann's Encyclopedia of Industrial Chemistry, T.Voeste et al., (2012) DOI: 10.1002/14356007.b03_07.pub2.

Within the meaning of the present invention, the term “physiologically acceptable medium” is understood to denote a medium suitable for the administration of a composition by the topical route. A physiologically acceptable medium is without unpleasant odour and/or unpleasant appearance, and is entirely compatible with the topical administration route.

The term “keratin material” is understood to mean the skin, the scalp, the lips and/or the superficial body growths, such as the nails and keratin fibres, such as, for example, body hair, the eyelashes, the eyebrows and head hair.

The term “cosmetic composition” is understood to mean, within the meaning of the invention, any composition applied to a keratin material in order to produce a non-therapeutic hygiene, care, perfuming, conditioning or make-up effect contributing towards improving the well-being and/or enhancing the beauty and/or modifying the appearance of the keratin material onto which said composition is applied.

The term “dermatological composition” is understood to mean, within the meaning of the invention, any composition applied to a keratin material in order to prevent and/or treat a disorder or dysfunction of said keratin material.

The term “cosmetic treatment” is understood to mean, within the meaning of the invention, any non-therapeutic perfuming, hygiene, care, conditioning or make-up effect contributing towards improving the well-being and/or enhancing the beauty and/or modifying the appearance or the odour of the keratin material onto which said composition is applied.

The term “high-frequency” ultrasound is understood to mean sound, the frequency of which is greater than 100 kHz and, for the very-high-frequencies, greater than 1 MHz.

The term “low-frequency” ultrasound is understood to mean sound, the frequency of which is between 16 and 100 kHz.

The Process for the Preparation of the “Concrete” and/or of the “Absolute”:

According to a particular embodiment of the invention, the first stage of the process for the preparation of the concrete and/or absolute can be preceded by the drying of the solid natural material(s) i) to x) as defined above and/or optionally by the grinding of natural material(s) i) to x) as defined above.

Stage of Drying Solid Natural Material

According to a particular embodiment of the invention, the natural material(s) i) to x) used in the process was (were), beforehand, washed and/or rinsed with water and/or dried in the open air or using conventional thermal means at a temperature preferably between 10° C. and 35° C., or else dehydrated in a thermal or microwave oven, or at ambient temperature using, for example, a desiccator, under or not under vacuum, in particular containing silica or P205, or using a dehydrator.

Grinding(s) Stage

According to a particular embodiment of the invention, one or more grinding(s) is(are) carried out on the fresh or dry natural material(s) i) to x) before bringing into contact with the heterocyclic solvent b) to result in the mixture a)+b). More particularly, the grinding(s) is(are) carried out at ambient temperature (25° C.) or at low temperature; in particular at a temperature of less than 0° C., of less than −10° C., more particularly of less than −30° C., more particularly still at a temperature of less than −70° C., in particular using dry ice, liquid nitrogen or a mixture including dry ice and/or liquid nitrogen, such as the combination of methanol and liquid nitrogen.

The grinding(s) of the natural material(s) i) to x) can be mechanical, such as the grinding using a pestle and mortar, a bead mill, a cryogenic grinder, a yagen, a planetary mill, an analytical mill, in particular having blades, a knife mill (blender) or using an industrial grinder/micronizer or industrial crusher, preferably an analytical mill, in particular having blades.

The grinding time depends on the result which is desired in terms of fineness of the ground material; generally, it is between 1 second and 5 minutes with an analytical mill, in particular having blades, preferably between 10 seconds and 1 minute, more preferentially between 20 seconds and 40 seconds.

According to another particular embodiment of the invention, the grinding of the natural material(s) is carried out after treatment with liquid nitrogen.

Preferably, the grinding(s) is(are) mechanical. More particularly, the grinding(s) is(are) carried out at ambient temperature (25° C.). More preferentially, the grinding(s) is(are) carried out on seeds, with or without shells, with or without the pod, of natural material(s), in particular plant natural material(s).

If the quality of the powder after grinding is not sufficiently fine, that is to say that the particles have a size of greater than 500 μm. the grinding stage can be repeated with the same appliance or on another grinding appliance, in particular a grinder/micronizer.

Ideally, the size of the powder obtained after grinding(s) is between 500 nm and 900 μm, more particularly between 100 nm and 500 m. The size of the powder obtained after grinding(s) is preferably between 500 nm and 100 μm, more particularly between 100 nm and 50 m.

The particle size of the powder is evaluated according to the light scattering analysis with a dry powder.

According to a preferred embodiment of the invention, the grinding(s) of natural material(s) is(are) carried out on seeds, with or without shells, with or without pod, preferably without shells.

The natural material(s) b):

Preferably, the fresh, withered or dry solid natural material(s) is(are) chosen from the following families:
i) flowers from: the four subgenera Rosa Plathyrhodon, Rosa Hesperhodos, Rosa Hulthemia and Rosa Eurosa and more particularly Rosa centifolia and Rosa damascena (rose), Jasminum and more particularly Jasminum grandiflorum and Jasminum sambac (jasmine), Lavandin stoechas, Lavandula hybrida, Lavandula augustifolia, formerly officinalis, and Lavandula latifolia and more particularly Lavandula hybrida abrial, Lavandula hybrida grosso, Lavandula hybrida reydovan, Lavandula hybrida sumian and Lavandula hybrida super (lavender and lavandin), Citrus sinensis or Citrus aurantium L (orange), Agave polianthes or Polianthes tuberosa (tuberoses), Cananga odorata (ylang-ylang) and Acacia dealbata or Acacia decurrens (mimosa);
ii) geranium, pelargonium with in particular Cicconium, Magnipetala, Parvulipetala, Paucisignata and more particularly Pelargonium graveolens (Geranium) stems and leaves, Pogostemon cablin and Pogostemon heyanus (patchouli) stems and leaves and Citrus aurantium, more particularly Citrus aurantium ssp. amara, or Citrus var. bigaradia, or Citrus aurantium ssp. aurantium, (petitgrain) stems and leaves;
iii) fruits chosen from Pimpinella anisum (anise), Coriandrum sativum (coriander), Carum carvi (caraway), Cuminum cyminum (cumin) and Juniperus, more particularly Juniperus Communis, Juniperus oxycedrus, Juniperus thurifera, Juniperus phoenicea L., (juniper);
iv) citrus fruits chosen from varieties of lemon, varieties of mandarin (Citrus reticulata), varieties of clementine (Citrus clementina), varieties of grapefruit, particularly bergamot (Citrus bergamia), lemon (Citronella, Citrus limonum), mandarin, such as Citrus reticulata, or of grapefruit (Citrus paradisi); preferably bergamot or grapefruit;
   preferably Citrus bergamia (bergamot), or Citrus paradisi (grapefruit);
v) Myristica fragrans (mace) seeds, Angelica archangelica (angelica) seeds, Apium graveolens (celery) seeds and Elettaria cardamomum (cardamom) seeds, Dipteryx odorata (tonka) seeds or beans, Vanilla planifolia (vanilla and/or vanilla pod), preferably Elettaria cardamomum (cardamom) seeds, Dipteryx odorata (tonka) seeds or beans and Vanilla planifolia (vanilla and/or vanilla pod) and more preferentially still cardamom;
vi) Angelica archangelica (angelica) roots, Vetiveria and more particularly Vetiveria zizanoide, Vetiveria nemoralis and Vetiveria nigritana (vetiver) roots and Iris, more particularly Iris germanica and Iris pallida (iris), roots;
vii) woods of Santalum and more particularly Santalum album, Santalum ellipticum, Santalum spicatum (sandalwood), woods of Aniba rosaeodora (rosewood), woods of Cedrus, more particularly Cedrus atlantica and Cedrus juniperus (cedarwood), and woods of Bulnesia sarmientioi, Guaiacum officinale and Guaiacum sanctum (guaiacumwood);
viii) herbs and grasses chosen from Artemisia dracunculus (tarragon), Cymbopogon and more particularly Cymbopogon citratus (lemon grass), Salvia and more particularly Salvia officinalis and Salvia sclarea (sage), Mentha and more particularly Mentha aquatica, Mentha canadensis, Mentha spicata (mint) and Thymus, more particularly Thymus vulgaris and Thymus zygis (thyme); ix) needles and twigs of spruce, needles and twigs of Abies and more particularly Abies alba (fir), needles and twigs of Salvia rosmarinus, formerly Romarinus officinalis (rosemary), and needles and twigs of Pinus and more particularly Pinus sylvestris (pine); and
x) resins and balms derived from Ferula galbaniflua or Ferula gummosa (galbanum), Canarium and more particularly Canarium commune, Canarium luzonicum and Canarium indicum (elemi), Styrax and more particularly Styrax tonkiniensis and Styrax benzoin (benzoin), Commiphora myrrha or Commiphora molmol and Commiphora opobalsamum (myrrh) and Boswellia, more particularly Boswellia sacra (olibanum).

In particular iv), the citrus fruits of the invention, are such as the varieties of Citrus bergamia (bergamot), the varieties of lemon grass, Citrus limonum (lemon), the varieties of Citrus reticulata (mandarin), the varieties of Citrus paradisi (grapefruit); preferably Citrus bergamia (bergamot) or Citrus paradisi (grapefruit).

According to a particular embodiment, the citrus fruits iv) of the invention are chosen from the varieties of lemon (lemon grass, Citrus limonum), such as calamondin, bergamot, kumquat, citron, finger lime, yellow lemon, green lemon, makrut lime and yuzu, the varieties of mandarin (Citrus reticulata) and of clementine (Citrus clementina), such as Nova, Encorce, Fortune, Ortanique, Nour or MA3, Cassar, Hernandina, Marisol, Nules, Caffin, the varieties of grapefruit (Citrus maxima, Citrus grandisa or Citrus paradisi), such as white or blood pomelo, white grapefruit, pink grapefruit, blood grapefruit; particularly bergamot (Citrus bergamia), lemon (lemon grass, Citrus limonum), mandarin (Citrus reticulata) or grapefruit (Citrus paradisi); preferably bergamot (Citrus bergamia) or grapefruit (Citrus paradisi).

According to a particular embodiment, iv) is different from citrus fruit peel.

According to a further embodiment, the fresh, withered or dry solid natural material(s) is(are) chosen from the families i) to iii) and v) to x) as defined above.

During the stage of bringing a) into contact with b) of the process of the invention, it is preferred to use one or more fresh, withered or dry solid natural material(s) chosen from i) flowers, such as lavender, lavandin, jasmine, rose and orange blossom, and ii) seeds, with or without shells, such as cardamom.

According to a particular alternative form of the invention, the fresh, withered or dry solid natural material(s) is(are) chosen from the materials i) as described above.

According to one embodiment, the fresh, withered or dry solid natural material(s) is(are) chosen from lavandin.

According to another embodiment, the fresh or dry solid natural material is jasmine flowers.

According to another embodiment, the fresh, withered or dry solid natural material is rose flowers.

According to another embodiment, the fresh, withered or dry solid natural material is flowers of tuberoses.

According to another embodiment, the fresh, withered or dry solid natural material is mimosa flowers.

According to another embodiment, the fresh or dry solid natural material is orange blossom.

According to another embodiment, the fresh or dry solid natural material is ylang-ylang flowers.

According to a second alternative form, the fresh or dry solid natural material(s) is(are) chosen from v) mace seeds, angelica seeds, celery seeds and cardamom (Elettaria cardamumum) seeds, tonka seeds or beans, vanilla pods or vanilla seeds, preferably cardamom seeds.

Preferably, the fresh, withered or dry solid natural raw material(s) chosen from b) is(are) chosen from the families chosen from i) and v).

According to a particular embodiment of the invention, the fresh, withered or dry solid natural material(s) b) as defined above is(are) chosen from the botanical families resulting from flowers, stems and leaves, fruits, peels of citrus fruits, seeds, roots, wood, herbs and grasses, needles and twigs of trees chosen from Citrus bergamia (bergamot), Aniba rosaeodora (rosewood or brazilian rosewood), family of Juniperus, Cupressus and Cedrus (cedarwood), lemon grass (lemon), Eugenia caryophyllata (clove), Ferula gummosa (galbanum), Pelargoneum graveolens (geranium), Jasminum officinale var. Grandiflorum (jasmine), Lavandula hybrida, Lavandula augustifolia, formerly officinalis, and Lavandula latifolia (lavandin, lavender), Evernia prunastri (oakmoss), Iris pallida and Iris germanica (orris), Citrus aurantium subspecies amara (orange blossom), Pogostemon cablin (patchouli), C. aurantium (petitgrain), Rosa, in particular Rosa damascena and Rosa centifolia (rose), Santalum album (sandalwood), Vetiveria zizanoides (vetiver), Viola odorata var. Victoria (violet), Cananga odorata (ylang-ylang) and Elettaria cardamomum (cardamom).

More preferentially, the fresh, withered or dry solid natural material(s) of the invention is(are) chosen from the following botanical families: Elettaria cardamomum (cardamom), Jasminum officinale var. Grandiflorum (jasmine), Rosa, in particular Rosa damascena and Rosa centifolia (rose), Citrus aurantium subspecies amara (orange blossom), and Lavandula augustifolia, formerly officinalis, and Lavandula latifolia (lavandin, lavender), and Acacia dealbata, Acacia decurrens (mimosa) flower.

Preferably, the fresh, withered or dry solid natural raw material(s) is(are) chosen from the families chosen from i) and v), more preferentially chosen from rose flowers, jasmine flowers, lavender flowers and lavandin flowers, mimosa flowers, flowers of tuberoses, cardamom seeds, tonka seeds or beans, vanilla pods and/or seeds.

The first system of solvent(s) a)

Preferably, the heterocyclic solvent has a boiling point at atmospheric pressure of between 70° C. and 100° C.

According to one embodiment of the invention, the system of solvent a) comprises at least one heterocyclic solvent chosen from:
a1) tetrahydrofuran derivatives, in particular (C₁-C₄)alkyltetrahydrofurans, and also their optical isomers, more particularly methyltetrahydrofurans, such as 2-methyltetrahydrofuran or “2-MeTHF”;
a2) tetrahydropyran derivatives, in particular (C₁-C₄)alkyltetrahydropyrans, more particularly methyltetrahydropyrans, and also their optical isomers, such as 4-methyltetrahydropyran (MTHP);
a3) diox(ol)ane derivatives, in particular 1,3-dioxolane; and
a4) (C₁-C₄)alkoxycyclopentane derivatives, such as methoxycyclopentane or “cyclopentyl methyl ether” or “CPME”, preferably CPME.

In particular, the system of solvent a) comprises at least one heterocyclic solvent a) chosen from a1), in particular a (C₁-C₄)alkyltetrahydrofuran, more particularly methyltetrahydrofuran, such as 2-methyltetrahydrofuran or “2-MeTHF”, and a4), such as methoxycyclopentane or CPME, preferably CPME.

According to a particular embodiment of the invention, a) comprises at least one solvent a4), preferably CPME.

Preferably, the system of solvent a) comprises at least one heterocyclic solvent a) chosen from a1) a tetrahydrofuran derivative, in particular a (C₁-C₄)alkyltetrahydrofuran, more particularly methyltetrahydrofuran, such as 2-methyltetrahydrofuran or “2-MeTHF”.

The 2-MeTHF can be enantiomerically pure (R) or (S), or in racemic form, or a mixture of these different forms, or a mixture of different (R) and (S) contents.

Preferably, the 1st system of solvents comprises at least 50% by volume of heterocyclic solvent having a boiling point of greater than or equal to 70° C. (preferably of between 70° C. and 110° C., more preferentially between 70° C. and 100° C.; in particular, the solvent(s) is(are) chosen from a1) to a4), preferably chosen from a1) and a4) as defined above; preferably, the heterocyclic solvent(s) are derived from THF, such as 2-MeTHF, or CPME, more preferentially 2-MeTHF), with respect to the total volume of the system of solvent, more preferentially at least 60% by volume of heterocyclic solvent as defined above, by volume, with respect to the total volume of the system of solvent, more preferentially still at least 80%, with respect to the total volume of the system of solvent, better still at least 90%, with respect to the total volume of the system of solvent, even better still 100% by volume, with respect to the total volume of the system of solvent.

More particularly, when the system of solvent(s) a) comprises one or more additional solvent(s) different from the heterocyclic solvent with a boiling point at atmospheric pressure of greater than or equal to 70° C., all the additional solvents are “green”.

According to a particular embodiment, the additional solvent(s) are chosen from:
(A) polar protic solvents or protogenic solvents, i.e. solvents having one or more hydrogen atoms capable of forming hydrogen bonds. Mention may be made of water and (C₁-C₈) alkanols with the alkane group linear or branched, in particular alcohols, such as bioethanol, or isopropanol;
(B) polar aprotic solvents, i.e. solvents having a non-zero dipole moment and devoid of hydrogen atoms capable of forming hydrogen bonds. Mention may be made, for example, of esters of organic acids, such as ethyl acetate, isopropyl acetate, propyl acetate, t-butyl acetate and C₁-C₄ alkyl carbonates, such as dimethyl carbonate, and
(C) non-polar aprotic solvents, i.e. having a zero permanent dipole moment. For example, hydrocarbons: linear or branched alkanes, cyclic alkanes, alkenes.
   Preferably, the additional solvent(s) are chosen from (A), (B) and their mixture.

More particularly, the “green” additional solvents different from the heterocyclic solvent(s) having a boiling point of greater than or equal to 70° C. of the invention are chosen from the following families:
esters of organic acids, such as ethyl acetate, isopropyl acetate, propyl acetate or t-butyl acetate, preferably isopropyl acetate;
alcohols, such as bioethanol, or isopropanol;
C₁-C₄ alkyl carbonates, such as dimethyl carbonate;
and their mixture.

According to one embodiment of the invention, the system of solvent(s) a) of the process is devoid of dimethyl carbonate. More particularly, the process of the invention does not employ dimethyl carbonate.

According to a particular embodiment, the first system of solvents exhibits a density of less than 2, and in particular of less than or equal to 1.5, preferably of between 0.7 and 1.5.

Each of the solvents used in the system of solvents exhibits a purity of at least 95%, in particular of at least 97%, especially of at least 99%.

Bringing the system of solvent(s) a) into contact with b) solid natural material(s)

According to a particular embodiment of the invention, the solid natural material(s) i) to x), ground or unground, in the form of preferably dry powder(s), as defined above, is(are) brought into contact a) with a first system of solvent(s), as defined above, to form a heterogeneous a)+b) mixture.

According to another particular embodiment of the invention, the solid natural material(s) i) to x), in particular the materials i) as defined above, are used fresh is(are) brought into contact a) with a first system of solvent(s), as defined above, to form a heterogeneous a)+b) mixture.

More particularly, the contacting operation is carried out at ambient temperature, with or without stirring, preferably with stirring. The natural material(s) i) to x) as defined above is(are) more particularly left to macerate or infuse at a temperature of between 10° C. and 37° C., such as 25° C., in the system of solvent(s) as defined above. According to another form of the invention, the contacting operation is carried out with heating at a temperature lower or equal by at least 1 to 5° C. than the boiling point of the solvent comprising the lowest boiling point, such as 45° C. Whatever the temperature at which a) is brought into contact with b), this contacting operation is carried out in a round-bottomed flask made of glass or metal, an industrial or non-industrial stainless steel vessel, having a single wall or a jacket, or any other reactor suitable for receiving solvents and natural materials. The duration of maceration or infusion of said a)+b) mixture is preferably between a few seconds and a week, more particularly between 30 minutes and 48 hours, more particularly still between 1 hour and 36 hours, better still between 2 hours and 24 hours, even better still between 2 hours and 6 hours. The maceration or infusion can be carried out with stirring, i.e. the a)+b) mixture can be kept stirred mechanically, preferably at a rotational speed of between 10 revolutions/minute and 1200 revolutions/minute, in particular between 100 revolutions/minute and 900 revolutions/minute, more particularly still between 200 revolutions/minute and 850 revolutions/minute, such as 750 revolutions/minute.

According to one embodiment, after mixing a)+b), said mixture is subjected to a sonication stage, in particular by putting said mixture in a high- or low-frequency ultrasonic bath, preferably at frequencies of between 5 and 40 kHz. Preferably, the sonication time is between 5 seconds and 1 hour, more preferentially between 10 seconds and 30 minutes, more preferentially still between 30 seconds and 10 minutes, such as 5 minutes. The temperature during this sonication stage is between 0° C. and 90° C., preferably between 5° C. and 45° C.

According to one embodiment, after mixing a)+b), a sonication of said mixture is optionally carried out as defined above; and then a stage of heating said mixture at a temperature of greater than 20° C., particularly of greater than 50° C., more particularly at a temperature of greater than 70° C., more particularly still up to reflux of said solvent(s) of the system of solvents, is optionally carried out; preferably, said mixture is heated to a temperature of between 70° C. and 100° C. Preferentially, the a)+b) mixture is heated for a period of time of between 5 minutes and 48 hours, particularly between 30 minutes and 24 hours, more particularly between 1 hour and 12 hours, more preferentially still between 2 hours and 5 hours.

The a)+b) mixture can be kept stirred mechanically, preferably at a rotational speed in particular of between 10 revolutions/minute and 1200 revolutions/minute, in particular between 100 revolutions/minute and 900 revolutions/minute, more particularly still between 200 revolutions/minute and 850 revolutions/minute, such as 750 revolutions/minute.

According to a particular embodiment, during the heating of the mixture, the reactor in which the a)+b) mixture is found comprises a cooling system or condenser for cooling and condensing the solvent(s) of the system of solvent(s) a). More preferentially, the reactor is an extractor of Soxhlet type or a reactor provided with a mechanical stirrer and equipped with a water-cooled or helical condenser, preferably a reactor provided with a mechanical stirrer and equipped with a water-cooled or helical condenser. In the latter case, the system of solvent(s) is advantageously brought to reflux of said solvent(s) of the system of solvent(s), in particular to a temperature of greater than or equal to 70° C.; preferably, said mixture is heated to a temperature of between 70° C. and 100° C. Preferentially, the a)+b) mixture is heated for a period of time of between 5 minutes and 48 hours, particularly between 30 minutes and 24 hours, more particularly between 1 hour and 12 hours, more preferentially still between 2 hours and 5 hours.

According to a particular embodiment of the invention, after the stage of heating the a)+b) mixture, the mixture is allowed to return to ambient temperature or cooled to ambient temperature and is left under mechanical stirring as defined above, or not, particularly between 30 minutes and 48 hours, more particularly still between 1 hour and 36 hours, better still between 2 hours and 24 hours.

More particularly, the contacting stage is a “solid/liquid extraction” stage.

According to a particular embodiment, the solid/liquid extraction stage is carried out by means of a Soxhlet extractor. In the latter case, the system of solvents is advantageously brought to reflux of said solvent(s) of the system of solvents, in particular to a temperature of greater than or equal to 70° C.; preferably, said mixture is heated to a temperature of between 70° C. and 100° C.

According to a particular embodiment, the solid/liquid extraction stage is carried out by means of a reactor provided with a mechanical stirrer and equipped with a water-cooled or helical condenser. In the latter case, the system of solvents is advantageously brought to reflux of said solvent(s) of the system of solvents, in particular to a temperature of greater than or equal to 70° C.; in particular, said mixture is heated to a temperature of between 70° C. and 110° C.; preferably, said mixture is heated to a temperature of between 70° C. and 100° C. According to another alternative form, when, for example, the plant natural material(s) are flowers, in particular jasmine flowers or mimosa flowers, or vanilla seeds and/or pods, the system of solvents is not brought to reflux but is maintained at a temperature of less than or equal to 45° C. The contacting and solid/liquid extraction stage is followed by a stage of recovery of the natural extract, preferably plant natural extract, resulting from the natural material(s), preferably plant natural material(s). This recovery can be carried out by filtration, distillation or with an extractor of Soxhlet type.

The solvent(s) of the extract(s) can be removed by desolventization. Mention may be made, for example, as desolventization process, of the evaporation of solvent(s), preferably under vacuum, for example using a rotary evaporator combined with a vacuum pump, an industrial evaporator, or else with a distillation apparatus, in order to obtain, after separation, extraction and evaporation of the solvent(s), a perfume concrete.

According to another alternative form of the process of the invention, the stage of recovery of the extract is carried out by separation of the natural material(s) which has(have) not been dissolved (also called precipitate) from its supernatant comprising said solvent(s). The separation of the precipitate from the solvent(s) is carried out by conventional methods known to a person skilled in the art. Mention may be made, for example, of the filtration method, or chromatography. The solvent(s) can be removed from the supernatant by desolventization as defined above; if need be, said desolventized supernatant can be purified again by one or more conventional purification method(s) known to a person skilled in the art. Mention may be made, for example, of chromatography, distillation under or not under reduced pressure, and/or recrystallization, in order to obtain a concrete. The concrete is more or less viscous and can exist in the form of a thick waxy residue.

Preferably, the preparation process of the invention is a process for the preparation of a perfume concrete employing:
1) at least one stage of bringing:
   a) a first system of solvents comprising at least one heterocyclic solvent having a boiling point at atmospheric pressure of greater than or equal to 70° C., in particular of between 70° C. and 110° C., preferably of between 70° C. and 100° C.; preferably, the heterocyclic solvent is chosen from a1) to a4), more preferentially a1) or a4) as defined above, in particular derived from THF, such as 2-MeTHF, or CPME, preferably 2-MeTHF; into contact with
   b) one or more solid natural material(s) chosen from i) to x) as defined above; then
2) the a)+b) mixture is optionally subjected to a sonication stage, in particular by putting said mixture in an ultrasonic bath; preferably, the sonication time is between 5 seconds and 1 hour, more preferentially between 10 seconds and 30 minutes, more preferentially still between 30 seconds and 10 minutes, such as 5 minutes;
3) followed by a stage of heating the a)+b) mixture to a temperature of greater than 70° C., particularly up to reflux of said solvent(s) of the system of solvents; preferably, said mixture is heated to a temperature of between 70° C. and 110° C., in particular of between 70° C. and 100° C. Preferably, the reactor in which the a)+b) mixture is found comprises a cooling system or condenser; more preferentially, the reactor is an extractor of Soxhlet type or a distillation apparatus; preferentially, the a)+b) mixture is heated for a period of time of between 5 minutes and 48 hours, particularly between 30 minutes and 24 hours, more particularly between 1 hour and 12 hours, more preferentially still between 2 hours and 5 hours;
then
4) the solvent(s) of the extract is(are) removed, preferably under vacuum, for example using a rotary evaporator combined with a vacuum pump, an industrial evaporator, or else with a distillation apparatus, to result in the concrete; or else the natural material(s) which has(have) not been dissolved is(are) separated from its(their) supernatant(s), the separation being carried out preferably by filtration or by chromatography; the supernatant(s) can subsequently be separated and recovered and the solvent(s) of said supernatant(s) is(are) removed by evaporation of solvents as defined above, to result in the concrete.

The concrete(s) obtained with the process of the invention can also be used or packaged in a wax or in a natural fatty substance.

The second system of solvent(s)

According to an advantageous alternative form in the process of the invention, the concrete is brought into contact with at least one second system of polar solvent(s), preferably polar protic solvent(s), comprising at least one polar protic solvent, in particular (C₂-C₆)alkanol, which is(are) “green” or of natural origin, such as bioethanol.

According to one embodiment of the invention, the second system of solvent(s) comprises at least one polar protic solvent, in particular chosen from (C₂-C₆)alkanol, which is(are) “green” or of natural origin, such as bioethanol, in an amount representing at least 10% by volume, with respect to the total volume of the second system of solvent, more preferentially at least 30%, more preferentially still at least 60%, preferably at least 80%, better still at least 90% by weight, even better still 100% by weight, with respect to the total volume of the second system of solvent. When the second system of solvent comprises a solvent mixture, preferably the system of solvent comprises two solvents and the preferred additional solvent is of the same polarity as the first solvent and is miscible with the first solvent; more particularly, the second solvent of the second system of solvent is water. Preferably, there is only a single solvent in the second system of solvent, which is ethanol, more particularly bioethanol.

According to an advantageous alternative form of the invention, once the second system of polar protic solvent(s) has been added to the concrete, the concrete+solvent(s) mixture is maintained at a temperature of less than 0° C., more preferentially of less than or equal to −10° C. Subsequently, the pellet is separated from the supernatant, preferably by centrifuging, then the solvent(s) is(are) evaporated from the supernatant, preferably under vacuum, for example using a rotary evaporator combined with a vacuum pump, an industrial evaporator, or else with a distillation apparatus, in order to obtain, after separation, and evaporation of the solvent(s), a perfume absolute.

According to another alternative form, the stage of bringing the concrete into contact with the second system of solvent(s) can be carried out with or without stirring, preferably with stirring. The operation of bringing the concrete into contact with the second system of solvent(s) can be carried out at a temperature of between 10° C. and 37° C., such as 25° C., in the system of solvent(s) as defined above, or at a temperature lower or equal by 1 to 5° C. than the boiling point of the solvents comprising the lowest boiling point, in a round-bottomed flask made of glass or of metal (stainless steel), an industrial or non-industrial vessel made of glass or of metal (stainless steel), or any other reactor suitable for receiving solvents, natural materials and concrete.

The duration of the operation of bringing the concrete into contact with the second system of solvent(s) is preferably between a few seconds and 2 days, more particularly between 5 minutes and 24 hours, more particularly still between 10 minutes and 12 hours, better still between 15 minutes and 2 hours.

According to a particular embodiment of the process of the invention, the operation of bringing the concrete into contact with the second system of solvent(s) is followed by a sonication stage, in particular by putting said mixture in an ultrasonic bath. Preferably, the sonication time is between 5 seconds and 1 hour, more preferentially between 10 seconds and 30 minutes, more preferentially still between 30 seconds and 10 minutes, such as 5 minutes.

According to a preferred embodiment, the mixture of the concrete and of the second system of solvent(s) is maintained at a temperature of less than 0° C., more preferentially of less than or equal to −10° C., for a period of time of between 5 minutes and 48 hours, particularly between 5 minutes and 24 hours, more particularly between 5 minutes and 2 hours, more preferentially still between 5 minutes and 1 hour. Subsequently, the pellet is separated from the supernatant, preferably by centrifuging, then the solvent(s) is(are) evaporated from the supernatant, preferably under vacuum, for example using a rotary evaporator combined with a vacuum pump, an industrial evaporator, or else with a distillation apparatus, in order to obtain, after separation, and evaporation of the solvent(s), a perfume absolute.

According to an alternative form of the process of the invention, the stage of recovery of the absolute is carried out by separation of the precipitate of the concrete which has not been dissolved in the second system of solvent(s) and of its supernatant comprising said solvent(s) of the second system of solvent(s).

The separation of the precipitate of the concrete and of the supernatant is carried out by conventional methods known to a person skilled in the art. Mention may be made, for example, of the filtration method, or chromatography.

The solvent(s) of the second system of solvent(s) can be removed from the supernatant by desolventization as defined above, preferably by evaporation under reduced pressure; if need be, said desolventized supernatant can be purified again by a conventional purification method known to a person skilled in the art. Mention may be made, for example, of chromatography, distillation under or not under reduced pressure, and/or recrystallization, in order to obtain an absolute.

The absolutes are generally viscous and oily materials.

According to a particular embodiment of the invention, the concretes and absolutes, both obtained by total extraction of plant solid natural material and not forming the subject of any form of distillation other than the removal of the solvents by desolventization, are complex mixtures containing numerous chemical types over a broad weight scale. Even if the volatile materials comprise only a very small part of the total, the concretes and absolutes obtained with the process of the invention have powerful odours and contribute to the perfumes in which they are used. Furthermore, the odours are persistent.

The Composition:

Another subject-matter of the invention is a composition, in particular a cosmetic composition, preferably a perfuming composition, comprising at least one concrete and/or at least one absolute, it being understood that said concrete(s) and/or said absolute(s) is(are) obtained by the preparation process as defined above.

According to one embodiment, the composition of the invention contains one or more concrete(s) obtained with the preparation process as defined above.

According to a preferred embodiment, the composition of the invention contains one or more absolute(s) obtained with the preparation process as defined above.

The cosmetic compositions according to the invention are cosmetically acceptable, i.e. they comprise only ingredients which are cosmetic ingredients, i.e. which do not detrimentally affect keratin materials and which are suitable for a cosmetic use.

According to a particular embodiment of the invention, the composition is anhydrous. When the composition is anhydrous, it generally comprises one or more fatty substances, which are liquid at 25° C. and atmospheric pressure, pasty substances, or substances in the form of waxes. The liquid fatty substances, pasty substances and waxes are more particularly as defined below.

According to another embodiment of the invention, the composition is aqueous. Generally, the compositions of the invention comprise a support which generally contains water or a mixture of water and of one or more organic solvents or a mixture of organic solvents; preferably, the organic solvent(s) are “green”.

The Organic Solvents:

Mention may be made, as organic solvent, for example, of lower C₂-C₄ alkanols, such as ethanol and isopropanol; polyols and polyol ethers, such as 2-butoxyethanol, propylene glycol, propylene glycol monomethyl ether, diethylene glycol monoethyl ether, diethylene glycol monomethyl ether or hexylene glycol; and also aromatic alcohols, such as benzyl alcohol or phenoxyethanol.

According to a particular embodiment, the perfuming composition is aqueous. More particularly, it is an aqueous/alcoholic composition comprising (C₂-C₄)alkanols which are more particularly “green”, preferably ethanol which is more preferentially “green”, such as bioethanol. The amount of organic solvent, which is preferably “green”, and in particular of (C₂-C₄)alkanols, is preferably between 1% by weight and 80% by weight, more particularly between 5% and 50% by weight, preferentially between 10% and 30% by weight, with respect to the total weight of the perfuming composition.

According to a particular embodiment, the organic solvents, which are preferably “green”, and in particular the (C₂-C₄)alkanols, are present in proportions of between 1% and 40% by weight approximately, with respect to the total weight of the composition, and more preferentially still between 5% and 30% by weight approximately.

The Adjuvants:

The composition(s) of the invention can also include various adjuvants conventionally used in cosmetic compositions, such as anionic, cationic, non-ionic, amphoteric or zwitterionic emulsifiers or surface-active agents or their mixtures, anionic, cationic, non-ionic, amphoteric or zwitterionic polymers or their mixtures, inorganic or organic thickening agents, and in particular anionic, cationic, non-ionic and amphoteric polymeric associative thickening agents, antioxidants, penetrating agents, sequestering agents, fragrances other than those of the concrete or absolute of the invention, antiperspirants, buffers, dispersing agents, conditioning agents, film-forming agents, ceramides, preserving agents, opacifying agents and fatty substances, in particular oils.

The above adjuvants are generally present in an amount of, for each of them, between 0.01% and 40% by weight, with respect to the weight of the composition, preferably between 0.1% and 20% by weight, with respect to the weight of the composition.

Of course, a person skilled in the art will take care to choose this or these optional additional compound(s) in such a way that the advantageous properties intrinsically attached to the composition(s) of use in the method for the perfuming or treatment of keratin materials in accordance with the invention are not, or not substantially, detrimentally affected by the envisaged addition(s).

The compositions according to the invention can be packaged in the form of bottles. They can also be applied in the form of fine particles by means of pressurization devices. The devices in accordance with the invention are well known to a person skilled in the art and comprise non-aerosol pumps or “atomizers”, aerosol containers comprising a propellant and also aerosol pumps using compressed air as propellant. The latter are described in U.S. Pat. Nos. 4,077,441, 4,850,517 (forming an integral part of the content of the description).

The compositions packaged as an aerosol in accordance with the invention generally contain conventional propellants, such as, for example, hydrofluorinated compounds, dichlorodifluoromethane, difluoroethane, dimethyl ether, isobutane, n-butane, propane or trichlorofluoromethane.

The compositions according to the invention can be provided in all the presentation forms conventionally used for a topical application and in particular in the form of aqueous or aqueous/alcoholic solutions, of oil-in-water (O/W), water-in-oil (W/O) or multiple (triple: W/O/W or O/W/O) emulsions, of aqueous gels, of dehydrated anhydrous products, such as free or compact perfuming powders, or of dispersions of an oily phase in an aqueous phase using lipid vesicles of ionic (liposomes) and/or non-ionic type. These compositions are prepared according to the usual methods.

In addition, the compositions according to the invention can be more or less fluid and can have the appearance of a liquid, a cream, an ointment, a milk, a lotion, a serum, a paste or a foam. They can also be provided in solid form, for example in the form of a stick.

When the composition according to the invention comprises an oily phase, it preferably contains at least one oil, in particular a physiologically acceptable oil. It can contain other fatty substances than oils, in particular vegetable oils, more preferentially natural oils.

The Method for the Treatment of Keratin Materials:

Preferably, the method for the treatment of keratin materials of the invention is a method for the treatment of human keratin materials, such as the skin, or human keratin fibres, such as the hair, employing the application of one or more concrete(s) and/or of one or more absolute(s), by application of the concrete(s) and/or of the absolute(s) obtained from the preparation process as defined above, it being understood that said concrete(s) and/or the absolute(s) can be contained in a composition as defined above.

More preferentially, the method for the treatment of keratin materials of the invention is a method for the treatment of human keratin materials, such as the skin, or human keratin fibres, such as the hair, employing the application of one or more absolute(s), by application of said absolute(s) obtained from the preparation process as defined above, it being understood that the absolute(s) can be contained in a composition as defined above.

The invention will now be described with reference to the following examples, given by way of illustration and without limitation. In these examples, unless otherwise indicated, the amounts are expressed as percentages by weight. The following scented compositions were prepared; the amounts are shown as percentages by weight.

### EXAMPLES

Solvents

Ethanol denotes 96% ethanol and the 2-MeTHF is the racemic form with a purity of greater than 99% (“green” polar aprotic solvent, according to the invention): heptane (non-polar aliphatic solvent) and 2-MeTHF (sold, for example, by Pennakem).

### Example 1

Preparation of the solid natural material:

Cardamom, or Elettaria cardamomum, belongs to the family of the Zingiberaceae.

Resulting from long-rhizome herbaceous plants, it produces oval capsules of 1 cm containing approximately twenty seeds each, which are separated into three air cells. These capsules, usually taken from plants aged from 3 to 5 years, were bought in a herbalist's shop. Depending on the experiments, the extraction was carried out starting:
either from crushed whole capsules (shells+seeds)
or from shells
or from isolated whole seeds
or from isolated seeds finely ground using an IKA A11 knife mill.

In this case, the grinding is carried out in three times 20 seconds in the presence of a chunk of dry ice in order to prevent the natural material from heating.

The separation of the seeds from their capsules, the preparation of the natural materials (cardamom shells, whole cardamom seeds and crushed seeds) and the corresponding extraction were carried out on the same day.

Extraction of the Concrete with the Solvent of the Invention

TABLE 1

| | | Biomass | | | Reflux | Absolute |
|---|---|---|---|---|---|---|
| Tests | Biomass | amount | | Solvent | time | yield |
| 1 | whole seeds + | 47.5 g (30 g | | 2-MeTHF | 2 h | 1.1% |
| | shells (crushed) | seeds + | | (475 g) | | |
| | | 16.1 g shells) | | | | |
| 2 | whole seeds | 30 | g | 2-MeTHF | 2 h | 1% |
| | | | | (300 g) | | |
| 3 | shells | 16.1 | g | 2-MeTHF | 2 h | 1.2% |
| | | | | (161 g) | | |
| 4 | whole seeds | 50 | g | 2-MeTHF | 2 h | 1.07% |
| | | | | (500 g) | | |
| 5 | whole seeds | 50 | g | 2-MeTHF | 5 h | 1.5% |
| | | | | (500 g) | | |
| 6 | whole seeds | 50 | g | 2-MeTHF | 5 h | 2.1% |
| | | | | (500 g) | | |
| 7 | ground seeds | 60 | g | 2-MeTHF | 5 h | 6% |
| | | | | (600 g) | | |

Olfactory Evaluation:

The blind tests were carried out on a panel of 10 people, including 5 specialist persons, including 5 perfumers. The samples used are:

A commercial cardamom absolute reference extracted with a conventional solvent different from that of the invention (such as n-hexane).

The cardamom absolutes obtained according to the preceding examples.

Of the 10 people, the great majority (70%) found that the reference absolute had the least pleasant odour of the five samples and one very distant from cardamom seeds. In terms of preferences, they placed a higher value on the cardamom absolute obtained after extraction from 2-MeTHF than that extracted with the conventional solvent (crushed or uncrushed seeds).

### Example 2

Preparation of the Solid Natural Material:

Lavandin, or Lavandula augustifolia, belongs to the family of the Lamiaceae.

This plant produces long stems of scented violet flowers. The latter are taken in order to be subsequently used for the extraction. For its part, the stem is not used in order to prevent an excessively herbaceous perfume note being obtained. The ready-for-use biomass is subsequently brought into contact with the solvent, 2-MeTHF, with a 1:10 ratio (1 g of biomass per 10 ml of solvent) in a 1 L Radleys® jacketed reactor. The heterogeneous reaction medium is subsequently stirred (6500 rpm) at ambient temperature and is then brought to reflux of the solvent for 2 hours. The reaction medium is subsequently allowed to return to ambient temperature.

After the extraction, the dark macerated product is recovered and filtered using a disposable conical filter, in order to remove the biomass residues, and then put on the rotary evaporator in order to remove the solvent. A viscous liquid is obtained.

The latter is subsequently taken up with absolute ethanol (ratio 1/30 (1 g of concrete per 30 g of ethanol)); the alcoholic medium is maintained in an ice bath at approximately −10° C. for half an hour in order to precipitate the waxes in particular, before being centrifuged in an Eppendorf® 5810R centrifuge at 23° C. and at 4000 rpm for 15 minutes. The supernatant is subsequently placed in a round-bottomed flask in order to be put on the rotary evaporator in order to remove the ethanol. Subsequently, the viscous liquid obtained is put in a desiccator under vacuum at 40° C. for half an hour in order to remove any trace of residual solvent. The absolute is then obtained.

The following test with the lavandin biomass was carried out:

TABLE 2

| | | Biomass | | Reflux | Absolute |
|---|---|---|---|---|---|
| Tests | Biomass | amount | Solvent | time | yield |
| 8 | flower | 100 g | 2-MeTHF | 2 h | 12% |
| | | | (1000 g) | | |

Olfactory Evaluation:

A blind test was carried out on a panel of several people, including some who are specialists in perfumery. The samples used are:

A commercial lavandin absolute reference.

The lavandin absolute obtained above.

The lavandin absolute obtained with 2-MeTHF is more pleasant, identical at the olfactory level to the fragrance of the flower and to the reference with, however, a greener note than the commercial lavandin absolute.

### Example 3

Preparation of the Solid Natural Material:

Jasmine, or Jasminum officinale var. Grandiflorum, belongs to the family of the Oleaceae.

This plant produces long branched stems variegated with numerous scented white flowers. The latter are picked in the small hours and form the subject of a rapid treatment in order to prevent them from losing their olfactory property. The ready-for-use biomasses are subsequently brought into contact with the solvent, 2-MeTHF, with a 1:10 ratio (1 g of biomass per 10 ml of solvent) in a 1L Radleys® jacketed reactor. The heterogeneous reaction medium is subsequently stirred (340 rpm) at ambient temperature and is then brought to reflux of the solvent for 2 hours. The reaction medium is subsequently allowed to return to ambient temperature.

After the extraction, the macerated product is recovered and filtered using a disposable conical filter, in order to remove the biomass residues, and then put on the rotary evaporator in order to remove the solvent. A viscous liquid is obtained. The latter is subsequently taken up with absolute ethanol (ratio 1/30 (1 g of concrete per 30 g of ethanol)); the alcoholic medium is maintained in an ice bath at approximately −10° C. for half an hour in order to precipitate the waxes in particular, before being centrifuged in an Eppendorf® 5810R centrifuge at 23° C. and at 4000 rpm for 15 minutes. The supernatant is subsequently placed in a round-bottomed flask in order to be put on the rotary evaporator in order to remove the ethanol. Subsequently, the viscous liquid obtained is put in a desiccator under vacuum at 40° C. for half an hour in order to remove any trace of residual solvent. The absolute is then obtained.

Another cardamom absolute was obtained under the same conditions as those described above, this time using n-heptane as extraction solvent in order to establish a comparative.

The following tests with the cardamom biomass were carried out:

TABLE 3

| | | Biomass | | Reflux | Absolute |
|---|---|---|---|---|---|
| Tests | Biomass | amount | Solvent | time | yield |
| 1 | whole seeds + | 47.5 g (30 g | 2-MeTHF | 2 h | 1.1% |
| | shells (crushed) | seeds + | (475 g) | | |
| | | 16.1 g shells) | | | |
| 2 | whole seeds | 30 g | 2-MeTHF | 2 h | 1% |
| | | | (300 g) | | |
| 3 | shells | 16.1 g | 2-MeTHF | 2 h | 1.2% |
| | | | (161 g) | | |
| 4 | whole seeds | 50 g | 2-MeTHF | 2 h | 2% |
| | | | (500 g) | | |
| 5 | whole seeds | 50 g | 2-MeTHF | 5 h | 2.3% |
| | | | (500 g) | | |
| 6 | whole seeds | 50 g | Heptane | 2 h | 1.7% |
| | | | (500 g) | | |
| 7 | ground seeds | 60 g | 2-MeTHF | 5 h | 6% |
| | | | (600 g) | | |

Olfactory Evaluation:

The blind tests were carried out on a panel of 10 people, including 5 specialist persons, including 5 perfumers. The samples used are:

A commercial cardamom absolute reference.

The cardamom absolutes obtained according to the preceding examples.

Of the 10 people, the great majority (70%) found that the reference absolute had the least pleasant odour of the five samples and one very distant from cardamom seeds. In terms of preferences, the great majority have also the cardamom absolute obtained after extraction from 2-MeTHF (crushed or uncrushed seeds). This absolute is described as being fresh and very close to how the seeds smell, in comparison with the absolute obtained with n-heptane.

### Example 4

Preparation of the solid natural material:

Vanilla, or Vanilla planifolia, belongs to the family of the Orchidaceae.

The flowers, joined in groups of 8 to 10, resemble those of numerous orchids. They are scented and white or green-yellow in colour. Vanilla flowers in autumn-winter between September and January, according to the cultivation zone.

The ripe fruit is completely odourless; its unique and valued odour is acquired after a fermentation process. This valued fruit owes its characteristic odour to the odorous principle called vanillin. The fruits or pods alone are used for the extraction. The biomass, finely ground with a grinder of IKA A11 mill type (size of a few millimetres), is ready for use and is then brought into contact with the solvent, 2-MeTHF, with a 1:10 ratio (1 g of biomass per 10 ml of solvent) in a 1 L Radleys® jacketed reactor. The heterogeneous reaction medium is subsequently stirred (6500 rpm) at ambient temperature and is then brought to 50° C. for 2 hours. The reaction medium is subsequently allowed to return to ambient temperature.

After the extraction, the dark macerated product is recovered and filtered using a disposable conical filter, in order to remove the biomass residues, and then put on the rotary evaporator in order to remove the solvent. A viscous liquid is obtained.

The latter is subsequently taken up with absolute ethanol (ratio 1/30 (1 g of concrete per 30 g of ethanol)); the alcoholic medium is maintained in an ice bath at approximately −10° C. for half an hour in order to precipitate the waxes in particular, before being centrifuged in an Eppendorf® 5810R centrifuge at 23° C. and at 4000 rpm for 15 minutes. The supernatant is subsequently placed in a round-bottomed flask in order to be put on the rotary evaporator in order to remove the ethanol. Subsequently, the viscous liquid obtained is put in a desiccator under vacuum at 40° C. for half an hour in order to remove any trace of residual solvent. The absolute is then obtained.

The Following Test with the Vanilla Pods was Carried Out:

TABLE 4

| | | Biomass | | Stirring | Absolute |
|---|---|---|---|---|---|
| Tests | Biomass | amount | Solvent | time/temperature | yield |
| 9 | pod | 100 g | 2-MeTHF | 2 h, 50° C. | 9.73% |
| | | | (1000 g) | | |

A vanilla absolute reference was also obtained by applying the same conditions as those defined with 2-MeTHF by extraction with n-heptane; the latter exhibits the same dissolving and extraction properties as the n-hexane conventionally used to obtain an absolute. The yield of absolute in this scenario is only 6.44%.

Olfactory Evaluation:

A blind test was carried out on a panel of several people, including some who are specialists in perfumery. The samples used are:

A vanilla absolute reference obtained by extraction with n-heptane.

The vanilla absolute obtained above by extraction with 2-MeTHF.

The vanilla absolute obtained with 2-MeTHF has a much more gourmet, “cake, rum” type, facet than the vanilla absolute obtained by extraction with heptane, the latter being more conventional and similar to a conventional commercial vanilla absolute. The intensity and the persistence of the odour are also greater with regard to the absolute obtained with 2-MeTHF, in comparison with the absolute obtained with n-heptane.

### Example 5

Preparation of the solid natural material:

Mimosa, or Acacia decurrens, Acacia dealbata, is a species of bush of the family of the Mimosaceae.

Mimosa is a tree or shrub, which can reach 25 m in height in the wild state; it has a smooth trunk grey-blue to grey-brown in colour, the base of which cracks with age. The flowers exist in the form of small yellow and silky pompoms 5 mm in diameter, arranged in panicles; they are used alone for the extraction. The ready-for-use biomass is brought into contact with the solvent, 2-MeTHF, with a 1:10 ratio (1 g of biomass per 10 ml of solvent) in a 1 L Radleys® jacketed reactor. The heterogeneous reaction medium is subsequently stirred (6500 rpm) at ambient temperature and is then brought to 45° C. for 2 hours. The reaction medium is subsequently allowed to return to ambient temperature.

After the extraction, the yellow macerated product is recovered and filtered using a disposable conical filter, in order to remove the biomass residues, and then put on the rotary evaporator in order to remove the solvent. A yellow waxy liquid is obtained.

The latter is subsequently taken up with absolute ethanol (ratio 1/30 (1 g of concrete per 30 g of ethanol)); the alcoholic medium is maintained in an ice bath at approximately −10° C. for half an hour in order to precipitate the waxes in particular, before being centrifuged in an Eppendorf® 5810R centrifuge at 23° C. and at 10 000 rpm for 10 minutes. The supernatant is subsequently placed in a round-bottomed flask in order to be put on the rotary evaporator in order to remove the ethanol. Subsequently, the yellow liquid obtained is put in a desiccator under vacuum at 40° C. for half an hour in order to remove any trace of residual solvent. The absolute is then obtained.

The following test with the mimosa flowers was carried out:

TABLE 5

| | | Biomass | | Stirring | Absolute |
|---|---|---|---|---|---|
| Tests | Biomass | amount | Solvent | time/temperature | yield |
| 10 | flower | 100 g | 2-MeTHF | 2 h, 45° C. | 5% |
| | | | (1000 g) | | |

A mimosa absolute reference was also obtained by applying the same conditions as those defined with 2-MeTHF by extraction with n-heptane; the latter exhibits the same dissolving and extraction properties as the n-hexane conventionally used to obtain an absolute. The yield of absolute in this scenario is only 1.5%.

Olfactory Evaluation:

The mimosa absolute obtained with 2-MeTHF provides a more floral note which is pleasant and close to the biomass, in comparison with the absolute obtained with n-heptane.

### Example 6

Preparation of the Solid Natural Material:

Tonka bean, or cumaru, is a seed produced by several species of tropical trees of the family of the Fabaceae of the genera Dipteryx and Taralea: mainly Dipteryx odorata but also, in particular, Dipteryx alata and Taralea oppositifolia.

The beans, finely ground with a grinder of IKA A11 mill type (size of a few millimetres), are ready for use and are then brought into contact with the solvent, 2-MeTHF, with a 1:10 ratio (1 g of biomass per 10 ml of solvent) in a 1 L Radleys® jacketed reactor. The heterogeneous reaction medium is subsequently stirred (6500 rpm) at ambient temperature and is then brought to 40° C. for 2 hours. The reaction medium is subsequently allowed to return to ambient temperature.

After the extraction, the yellow macerated product is recovered and filtered using a disposable conical filter, in order to remove the biomass residues, and then put on the rotary evaporator in order to remove the solvent. A two-phase system (oil and brown residue) is obtained, unlike the other experiments carried out with different ones.

The oily phase is withdrawn in order to be able to carry out the following stage.

The brown residue is subsequently taken up with absolute ethanol (ratio 1/30 (1 g of concrete per 30 g of ethanol)); the alcoholic medium is maintained in an ice bath at approximately −10° C. for half an hour in order to precipitate the waxes in particular, before being centrifuged in an Eppendorf® 5810R centrifuge at 23° C. and at 10 000 rpm for 10 minutes. The supernatant is subsequently placed in a round-bottomed flask in order to be put on the rotary evaporator in order to remove the ethanol. Subsequently, the brown liquid obtained is put in a desiccator under vacuum at 40° C. for half an hour in order to remove any trace of residual solvent. The absolute is then obtained.

The following test with tonka beans was carried out:

TABLE 6

| | | Biomass | | Stirring | Absolute |
|---|---|---|---|---|---|
| Tests | Biomass | amount | Solvent | time/temperature | yield |
| 11 | beans | 100 g | 2-MeTHF | 2 h, 40° C. | 22.5% |
| | | | (1000 g) | | |

A tonka bean absolute reference was also obtained by applying the same conditions as those defined with 2-MeTHF by extraction with n-heptane; the latter exhibits the same dissolving and extraction properties as the n-hexane conventionally used to obtain an absolute. It should be noted that a two-phase system as described above was also obtained. The yield of absolute in this scenario is only 14%.

Olfactory Evaluation:

The tonka bean absolute obtained with 2-MeTHF provides a note of cut hay, of vanilla which is very powerful (much more powerful than that obtained with n-heptane), a note similar to the extracted biomass.

### Example 7

Preparation of the solid natural material:

The rose Rosa centifolia forms part of the family of the Rosaceae. As its name indicates, this is a rose having a hundred leaves. Its flowers are rather round and offer an attractive volume by virtue of the numerous and fine overlapping petals. The Centifolia rose tree is presented in the form of uniform and flexible bushes which can reach 1.5 metres to 2 metres in height. Flowering in the month of May, it is preferable to pick the Centifolia rose at daybreak, as this is the moment when its petals are richest in odorous active principles.

The roses after picking, which are ready for use, are brought into contact with the solvent, 2-MeTHF, with a 1:10 ratio (1 g of biomass per 10 ml of solvent) in a 1 L Radleys® jacketed reactor. The heterogeneous reaction medium is subsequently stirred (6500 rpm) at ambient temperature and is then brought to 35° C. for 2 hours. The reaction medium is subsequently allowed to return to ambient temperature.

After the extraction, the yellow macerated product is recovered and filtered using a disposable conical filter, in order to remove the biomass residues, and then put on the rotary evaporator in order to remove the solvent.

The orange-yellow residue is subsequently taken up with absolute ethanol (ratio 1/30 (1 g of concrete per 30 g of ethanol)); the alcoholic medium is maintained in an ice bath at approximately −10° C. for half an hour in order to precipitate the waxes in particular, before being centrifuged in an Eppendorf® 5810R centrifuge at 23° C. and at 10 000 rpm for 10 minutes. The supernatant is subsequently placed in a round-bottomed flask in order to be put on the rotary evaporator in order to remove the ethanol. Subsequently, the orange-yellow liquid obtained is put in a desiccator under vacuum at 25° C. for half an hour in order to remove any trace of residual solvent. The absolute is then obtained.

The following test with the Rosa centifolia flowers was carried out:

TABLE 7

| | | Biomass | | Stirring | Absolute |
|---|---|---|---|---|---|
| Tests | Biomass | amount | Solvent | time/temperature | yield |
| 12 | flowers | 100 g | 2-MeTHF | 2 h, 35° C. | 3.8% |
| | | | (1000 g) | | |

A Rosa centifolia flowers absolute reference was also obtained by applying the same conditions as those defined with 2-MeTHF by extraction with n-heptane; the latter exhibits the same dissolving and extraction properties as the n-hexane conventionally used to obtain an absolute. The yield of absolute in this scenario is only 0.28%.

Olfactory Evaluation:

The rose absolute obtained with 2-MeTHF provides a more floral note which is pleasant and relatively close to the biomass, in comparison with the absolute obtained with n-heptane.

### Example 8

Preparation of the Solid Natural Material:

Tuberose (Polyanthes tuberosa or Agave polianthes) is a herbaceous plant belonging to the genus Agave of the family of the Agavaceae or, more recently, to that of the Asparagaceae. Tuberose is a long-stemmed star-shaped white flower which has a strong personality with its heady odour.

Tuberoses after picking, which are ready for use, are brought into contact with the solvent, 2-MeTHF, with a 1:10 ratio (1 g of biomass per 10 ml of solvent) in a rotary evaporator of Hei-VAP Expert Control type. The heterogeneous reaction medium is subsequently stirred (280 rpm) at atmospheric pressure and at 25° C. for 2 hours.

After the extraction, the light-yellow macerated product is recovered and filtered using a disposable conical filter, in order to remove the biomass residues, and then put back on the rotary evaporator in order to remove the solvent.

The orange-yellow residue is subsequently taken up with absolute ethanol (ratio 1/30 (1 g of concrete per 30 g of ethanol)); the alcoholic medium is maintained in an ice bath at approximately −10° C. for half an hour in order to precipitate the waxes in particular, before being centrifuged in an Eppendorf® 5810R centrifuge at 23° C. and at 4000 rpm for 15 minutes. The supernatant is subsequently placed in a round-bottomed flask in order to be put on the rotary evaporator in order to remove the ethanol. Subsequently, the orange-yellow liquid obtained is put in a desiccator under vacuum at 25° C. for half an hour in order to remove any trace of residual solvent. The absolute is then obtained.

The following test with the Polyanthes tuberosa flowers was carried out:

TABLE 8

| | | Biomass | | Stirring | Absolute |
|---|---|---|---|---|---|
| Tests | Biomass | amount | Solvent | time/temperature | yield |
| 13 | flowers | 80 g | 2-MeTHF | 2 h, 25° C. | 0.72% |
| | | | (800 g) | | |

Olfactory Evaluation:

The tuberose absolute obtained with 2-MeTHF provides a round, pleasant and powerful floral note relatively close to the biomass.

### Example 9

Lavandin, or Lavandula augustifolia, belongs to the family of the Lamiaceae.

This plant produces long stems of scented violet flowers. The latter are taken in order to be subsequently used for the extraction. For its part, the stem is not used in order to prevent an excessively herbaceous perfume note being obtained. The ready-for-use biomass is subsequently brought into contact with the solvent, CPME (CycloPentyl Methyl Ether), with a 1:10 ratio (1 g of biomass per 10 ml of solvent) in a rotary evaporator of Hei-VAP Expert Control type. The heterogeneous reaction medium is subsequently stirred (280 rpm) at atmospheric pressure and at 40° C. for 2 hours. The reaction medium is subsequently allowed to return to ambient temperature.

After the extraction, the dark macerated product is recovered and filtered using a disposable conical filter, in order to remove the biomass residues, and then put on the rotary evaporator in order to remove the solvent. A dark-green viscous liquid is obtained.

The latter is subsequently taken up with absolute ethanol (ratio 1/30 (1 g of concrete per 30 g of ethanol)); the alcoholic medium is maintained in an ice bath at approximately −10° C. for half an hour in order to precipitate the waxes in particular, before being centrifuged in an Eppendorf® 5810R centrifuge at 23° C. and at 4000 rpm for 15 minutes. The supernatant is subsequently placed in a round-bottomed flask in order to be put on the rotary evaporator in order to remove the ethanol. Subsequently, the viscous liquid obtained is put in a desiccator under vacuum at 40° C. for half an hour in order to remove any trace of residual solvent. The absolute is then obtained.

The following test with the lavandin biomass was carried out:

TABLE 9

| | | Biomass | | Stirring | Absolute |
|---|---|---|---|---|---|
| Tests | Biomass | amount | Solvent | time/temperature | yield |
| 14 | flowers | 50 g | CPME | 2 h, 40° C. | 11.6% |
| | | | (500 g) | | |

Olfactory Evaluation:

The lavandin absolute obtained with CPME was compared with a commercial absolute:

The lavandin absolute obtained with CPME is deep, with a powerful base note and very close at the olfactory level to the fragrance of the flower. It is also at the olfactory level very pleasant and superior to the commercial reference.

1. A process for the preparation of a perfume concrete and/or absolute comprising:
bringing a first system of solvent(s) comprising at least one heterocyclic solvent having a boiling point at atmospheric pressure of greater than or equal to 70° C. into contact with: one or more fresh, withered or dry solid natural material(s) chosen from:
i) rose flowers, jasmine flowers, lavender flowers, lavandin flowers, orange blossom, flowers of tuberoses, ylang-ylang flowers, and violet flowers and mimosa flowers;
ii) geranium, stems, geranium leaves, patchouli stems, patchouli leaves, petitgrain stems, and petigrain leaves;
iii) anise (Pimpinella anisum), coriander (Coriandrum sativum), caraway (Carum carvi), cumin (Cuminum cyminum) and juniper;
iv) varieties of mandarin (Citrus reticulata), varieties of clementine (Citrus clementina), and varieties of grapefruit;
v) mace (Myristica fragrans) seeds, angelica (Angelica archangelica) seeds, celery (Apium graveolens) seeds, cardamom (Elettaria cardamumum) seeds, tonka (Dipteryx odorata) seeds, tonka beans, vanilla (Vanilla planfolia) pods, and vanilla seeds;
vi) angelica (Angelica archangelica) roots, vetiver roots and iris;
vii) sandalwoods, rosewoods (Aniba rosaeodora), cedarwoods and guaiacumwoods;
viii) tarragon (Artemisia dracunculus), lemon grass, sage, mint and thyme;
ix) spruce needles, spruce twigs, fir needles, fir twigs, rosemary needles, rosemary twigs, pine needs and pine twigs;
and
x) resins and balms derived from galbanum, elemi, benzoin, myrrh and olibanum; to produce a mixture, it being understood that the seeds, pods, and beans v) can be with or without shells.

2. Process according to claim 1, in which the first system of solvent(s) comprises at least one heterocyclic solvent chosen from:
a1) tetrahydrofuran derivatives;
a2) tetrahydropyran derivatives;
a3) diox(ol)ane derivatives; and
a4) (C₁-C₄)alkoxycyclopentane derivatives.

3. Process according to claim 1, in which the first system of solvents) comprises at least one heterocyclic solvent chosen from a1) a tetrahydrofuran derivative.

4. Process according to claim 1, in which the first system of solvent(s) comprises one or more additional solvents different from the heterocyclic solvent(s) having a boiling point of greater than or equal to 70° C. selected from the group consisting of:
esters of organic acids;
alcohols;
C₁-C₄ alkyl carbonates;
and mixtures thereof.

5. Process according to claim 1, in which the first system of solvent(s) comprises at least 50% by volume of heterocyclic solvent having a boiling point of greater than or equal to 70° C., with respect to the total volume of the first system of solvent (s).

6. Process according to claim 1, in which the natural material(s) i) to x) has(have) been ground, before contacting the natural material(s) with the heterocyclic solvent having a boiling point of greater than or equal to 70° C.

7. Process according to claim 1, in which the natural material(s) is(are) chosen from i) and v).

8. Process according to claim 1, in which the contacting is carried out at ambient temperature, with or without stirring.

9. Process according to claim 1, in which the contacting is a solid/liquid extraction.

10. Process according to claim 1, further comprising heating the mixture in a reactor to a temperature of greater than 40° C. for a period of time of between 5 minutes and 48 hours.

11. Process according to claim 1, in which the reactor comprises a cooling system or condenser for cooling and condensing the solvent(s) of the first system of solvent(s).

12. Process according to claim 10, further comprising, prior to heating the mixture in the reactor, sonicating the mixture, and
subsequent to heating the mixture in the reactor, (a) removing the solvent(s) to produce a concrete; or (b) separating natural materials which have not been dissolved from the mixture to yield supernatant and removing the solvent(s)
to produce a concrete.

13. Process according to claim 12, in which the concrete is brought into contact with at least one second system of polar solvent(s) comprising at least one polar protic solvent and is maintained at a temperature of less than 0° C. to produce a pellet, and then separating the pellet from supernatant and evaporating solvent from the supernatant to produce a perfume absolute.

14. A concrete obtained by the preparation process according to claim 1.

15. An absolute obtained by the preparation process according to claim 13.

16. A composition comprising:
one or more concrete(s) obtained by the preparation process according to claim 1, and/or
one or more absolute(s) obtained by the preparation process according to claim 13.

17. A method for the treatment of keratin materials comprising applying of one or more concrete(s) of claim 14 and/or one or more absolute(s) of claim 15 to the keratin material.

18. A method for perfuming a substrate comprising comprising applying of one or more concrete(s) of claim 14 and/or one or more absolute(s) of claim 15 to the substrate.

19. A method of extracting a concrete and/or an absolute from solid natural material(s) i) to x) b) as defined in claim 1 comprising contacting the solid natural material(s) with at least one heterocyclic solvent having a boiling point at atmospheric pressure of greater than or equal to 70° C., as defined in claims 1—without an ether odor.

20. A method of perfuming a substrate comprising contacting one or more concrete(s) as defined in claim 14 and/or of one or more absolute(s) as defined in claim 15 with the substrate.
